(19) United States
(12) Patent Application Publication
(10) Pub. No.: US 2024/0316792 A1
(43) Pub. Date: Sep. 26, 2024

(54) VACUUM GRIPPER AND METHOD FOR OPERATING A VACUUM GRIPPER

(71) Applicant: J. Schmalz GmbH, Glatten (DE)

(72) Inventor: Walter SCHAAF, Freudenstadt-Grüntal (DE)

(21) Appl. No.: 18/577,905

(22) PCT Filed: Jul. 13, 2022
(86) PCT No.: PCT/EP2022/069616

§ 371 Date: Jan. 9, 2024

(30) Foreign Application Priority Data
Aug. 2, 2021 (DE) 10 2021 119 995.6

(51) Int. Cl. B25J 15/06

(52) U.S. Cl. CPC B25J 15/0616

(57) ABSTRACT

A vacuum gripper (10) includes a suction element (12) and a wear detection device (22) for detecting a state of wear of the suction element. The wear detection device includes a wearing section (36) which is itself subject to wear as the suction element wears in normal use; a fluid channel (24), which interacts with the wearing section in such a way that, as a result of wear of the wearing section, a flow cross-section of the fluid channel is altered and/or a fluid flow through the fluid channel is released in the first place, and a sensor device (38) for detecting a pressure in the fluid channel and/or a fluid flow through the fluid channel.

The invention relates to a vacuum gripper comprising a suction element and a wear detection device for detecting a state of wear of the suction element. The invention also relates to a method for operating such a vacuum gripper.

Vacuum grippers are used for gripping objects by means of negative pressure and are used, for example, as end effectors in vacuum handling systems. They usually comprise at least one suction element, which delimits an inner suction compartment and comprises a contact section or alternatively a sealing lip for laying up against an object to be gripped. In order to grip an object, the suction element is placed with the contact section against the object to be gripped and then the inner suction compartment of the suction element is pressurized. The inner suction compartment is then vented again to deposit the object.

Suction pads with differently shaped suction elements are known. By way of example, elastomer suction pads are known in which the suction element is made of an elastomer material, that clings against an outer surface of the object to be gripped during suctioning. Suction pads are also known in which the suction element consists of a porous foam material through which an object to be gripped can be suctioned in.

When such a suction element is used as intended, which is to say, in particular when an object is repeatedly suctioned in and deposited, the suction element is generally subject to wear due to use, in particular due to mechanical abrasion in the area of the contact section. Such use-related wear can lead to the sealing effect of the suction element being impaired and therefore an object can no longer be gripped with the desired reliability. It is therefore important to be able to monitor the state of wear of the suction element.

For this purpose, it is known, for example, from EP 1 816 094 B1 to equip the suction element, at least in sections, with an element the color of which changes over time and in this way represents a state of wear of the suction element.

The invention is based on the task of being able to reliably determine the state of wear of the suction element of a vacuum gripper by simple means.

This task is solved by a vacuum gripper with the features of claim 1.

The vacuum gripper comprises at least one suction element for suctioning of an object. In particular, the suction element can be an elastomer suction cup or a porous foam material. In particular, the suction element can be part of a higher-level suction gripper, for example, a surface suction gripper. In the course of its intended use, which is to say, in particular when repeatedly suctioning and depositing an object, the suction element is subject to wear, at least in sections, due to use. In particular, the suction element is subject to mechanical abrasion. The use-related wear occurs in particular in a contact section of the suction element, by means of which the suction element is placed against an object to be suctioned.

The vacuum gripper moreover comprises a wear detection device for detecting a state of wear, in particular a degree of wear, of the suction element. The wear detection device is, in particular, configured to detect whether and, if so, how much material of the suction element has already been worn away due to wear, for example, through frictional contact with a suctioned object.

The wear detection device comprises at least one wearing section, which wearing section is subject to wear, in particular mechanical abrasion, over the course of a use-related wear of the suction element itself. The wearing section is in particular a material section that is arranged in such a way that it is subject to mechanical abrasion over the course of use-related wear of the suction element itself. It is conceivable that the wearing section automatically wears out alongside the suction element, in particular at a rate correlating with the wear of the suction element. It is also conceivable that the wearing section only wears out when a predetermined degree of wear of the suction element is reached, in particular when a predetermined amount of wear of the suction element is reached (for example, only after several gripping cycles have been performed).

The wear detection device also comprises at least one fluid channel which interacts with the at least one wearing section in such a way that a flow cross-section, for example, for air flowing in and/or flowing through, of the fluid channel changes through wear of the at least one wearing section and/or a fluid flow, in particular air flow, is released through the fluid channel in the first place.

In this respect, the wearing section and fluid channel can, for example, be configured and interact with each other in such a way that when a predetermined degree of wear, in particular a predetermined material abrasion, of the wearing section is reached, a fluid flow through the fluid channel is initially released and then, as the wearing section wears, a flow cross-section of the fluid channel is changed or is no longer changed. It is also conceivable that a fluid flow through the fluid channel is already released when the vacuum gripper is new, but that a flow cross-section of the fluid channel is changed as the wearing section wears. In particular, the fluid channel and wearing section can be configured in such a way that the flow cross-section of the fluid channel increases as the wearing section wears. The fluid channel can, for example, be configured to run orthogonally, parallel or at an angle to the direction of wear.

The wear detection device also comprises a sensor device which is configured to detect a pressure in the fluid channel and/or a fluid flow, in particular air flow, through the fluid channel. For this purpose, the sensor device can, in particular, comprise a pressure sensor and/or a flow sensor. The pressure or alternatively flow sensor is, in particular, configured to measure a pressure or alternatively fluid flow and then to output the pressure or alternatively flow information as an electronic measurement signal, in particular, to transmit it to an evaluation device.

Such a vacuum gripper makes it possible to monitor the state of wear of the suction element reliably and automatically using simple means. The wear detection is based on the basic principle that a wearing section is itself subject to test wear over the course of use-related wear of the suction element, as a result of which the fluid properties of a fluid channel interacting with the wearing section are changed. A pressure in the fluid channel and/or a flow through the fluid channel is, in particular, changed as a result of the wear of the wearing section. Such a change in pressure or flow can then be detected by means of the sensor device and in this way a state of wear of the suction element can be inferred. The sensors used to measure pressure and/or flow are robust in their function, so that a reliable wear detection is favored. In addition, such sensors are available at comparatively low cost.

In the course of the intended use of the vacuum gripper, it can happen that the suction element is subject to particularly heavy wear at a certain location, for example, if the suction element always engages with an object using the same edge. In order to be able to detect local differences in wear, it can therefore be advantageous if a plurality of fluid channels and a plurality of wearing sections are provided. By way of example, the fluid channels and the wearing sections can then be distributed about the circumference of the suction element, for example, evenly distributed.

In particular, the wearing section provides a wall that at least partially delimits the fluid channel. In this respect, the wearing section is, in particular, a material section that delimits the fluid channel at least in sections.

The wearing section can, in particular, consist of a plastic, more particularly an elastomer. In this respect, no undesirable metallic abrasion is generated when the wearing section wears. Advantageously, the wearing section can consist of the same material as the suction element. The suction element and wearing section then have the same resistance to abrasion.

It is conceivable that the wearing section is provided by a wear body that is configured separate from the suction element. In this case, the fluid channel is, in particular, also configured in the wear body. The wear body can, for example, be arranged in such a way that a wearing surface of the wearing section is flush with the contact section of the suction element. The wear body can, for example, be connected to the suction element by means of a holding device. It is also conceivable that the wear detection device, in particular comprising the wearing section, fluid channel, and/or sensor device, is configured as a detection module provided separately from the suction element.

In an advantageous way, the wearing section can also be formed in one piece, in particular monolithically, with the suction element. The wearing section can, in particular, be provided by a suction element wall of the suction element. Preferably, the wearing section can be a partial section of the suction element wall, in particular a partial area of the contact section for laying up against an object to be suctioned. In this respect, such an embodiment enables direct and therefore particularly accurate measurement of the state of wear of the suction element. Such a vacuum gripper, moreover, has particularly cost-effective and compact construction, as the number of individual components is reduced.

In particular, the fluid channel can also be formed in the suction element. By way of example, it is conceivable that the fluid channel is delimited by a suction element wall, which is to say, is configured internally.

The wearing section and the fluid channel can, in particular, be configured in such a way that in a as-new, unworn state of the wearing section, the fluid channel is closed at a first channel end of the wearing section and that the first channel end is opened when the wearing section reaches a predetermined degree of wear, in particular when a predetermined amount of wear is exceeded. In this respect, the fluid flow through the fluid channel is, in particular, blocked when new. After the channel end is opened, fluid flow through the fluid channel is enabled, which can be detected by the sensor device as a change in pressure and/or flow. The specified degree of wear can, in particular, be a limit degree of wear of the suction element, whereupon the suction element must be replaced immediately or at least in the near future (for example, at the latest, after a further 100 gripping cycles.) It is possible that the wearing section and the fluid channel are configured in such a way that after opening of the fluid channel, the flow cross-section of the fluid channel changes, or remains constant, over the course of progressive wear of the wearing section. In the case where it remains constant, the fluid channel can, for example, be configured cylindrically.

In the framework of an advantageous embodiment, the wearing section and the fluid channel can be configured in such a way that the flow cross-section of the fluid channel changes continuously as the wearing section wears. This makes it possible to closely monitor, in particular in a continuous manner, the degree of wear of the suction element. The wearing section and the fluid channel can, in particular, be configured in such a way that the flow cross-section of the fluid channel increases as the wearing section wears.

The fluid channel can, in particular, widen or taper at least in sections. In this respect, the fluid channel can be configured in such a way that its flow cross-section progressively decreases or increases along its longitudinal extension, at least in sections. Preferably, the fluid channel widens at least in sections in the direction of wear, in particular in a direction orthogonal to a contact section of the suction element. In this respect, a flow cross-section of the fluid channel is increased over the course of progressive wear of the wearing section, which can then be detected as a change in pressure or flow by the sensor device. By way of example, it is conceivable that the wearing section widens in a funnel shape, in particular conically, in particular in the direction of wear.

In the framework of an advantageous embodiment, the wearing section and the fluid channel can be configured and interact with each other in such a way that a fluidic connection is established between the fluid channel and an inner suction compartment delimited by the suction element when a predetermined degree of wear is reached, in particular when a predetermined amount of wear is exceeded. In this respect, the wearing section and the fluid channel can be configured in such a way that the first channel end of the fluid channel opens into the inner suction compartment when the wearing section reaches a predetermined degree of wear. In such an embodiment, the degree of wear of the suction element can then be detected by sensing a change in pressure in the fluid channel or in the inner suction compartment, in particular if negative pressure is applied on the inner suction compartment. The sensor device can then, in particular, comprise a negative pressure sensor that interacts with the fluid channel or the inner suction compartment.

In an advantageous embodiment, the fluid channel can be configured in such a way that its second channel end facing away from the wearing section opens into an annular channel, in particular an annular groove, arranged on the suction element. Such an embodiment makes it possible to arrange the sensor device at any position along the annular channel and thus independently of the position and/or orientation of the fluid channel. It is moreover conceivable that a plurality of fluid channels are provided, which open into a common annular channel. The annular channel or alternatively the annular groove can be formed in one piece with the suction element. It is also possible that the annular channel or alternatively the annular groove is formed in a component provided separately from the suction element, for example, in the shape of a plate. Such an embodiment can facilitate a connection of the sensor device, in particular when using elastomer suction elements.

It can moreover be particularly advantageous if the fluid channel, in particular at its second channel end facing away from the wearing section, has a fluid interface for fluidic connection of the fluid channel. The fluid interface can, in particular, be configured to fluidically connect the fluid channel to the sensor device. By way of example, the fluid interface can be configured to connect a fluid line, in particular a hose.

In the framework of an advantageous embodiment, the fluid interface can be configured in one piece with the suction element, in particular if the fluid channel is configured in the suction element. As a consequence, the suction element and the fluid interface can be manufactured in one casting, which simplifies manufacture. Such an embodiment moreover reduces the number of connection points and therefore potential weak points.

In particular, the fluid interface may comprise a connection nipple that is configured in one piece with the suction element for the connection of a fluid line, in particular of a hose. Alternatively or additionally, the fluid interface may comprise a hose that is configured in one piece with the suction element and which opens into the fluid channel. The hose may, in particular, extend away from the suction element.

In the framework of an advantageous embodiment, the wear detection device can moreover comprise a pressure source that is fluidically connectable to or is connected to the fluid channel. The pressure source can, in particular, be configured to apply pressure to the fluid channel, particularly overpressure, more particularly with compressed air. The pressure source is, in particular, configured to constantly apply a predeterminable pressure to the fluid channel. By way of example, the pressure source can be a compressed air line or a negative pressure generating device. The pressure source can, in particular, be switchable by means of a valve and the application of pressure to the fluid channel can be controllable. For this purpose, the vacuum gripper can comprise a control device for controlling the pressure source, in particular for controlling the valve. The control device can, in particular, also interact with the sensor device, in particular can control the sensor device. The pressure provided by the pressure source can be used as a test pressure to detect a wear-related change in the fluid channel. By way of example, it is conceivable that a predetermined constant pressure is applied to the fluid channel. An opening of the fluid channel or a change in the flow cross-section of the fluid channel then leads, in particular, to a change in the air flow through the fluid channel, which can be detected by the sensor device as a change in pressure and/or flow. In this way, a state of wear of the suction pad can be detected under controlled conditions.

The wear detection device can moreover comprise an evaluation device that interacts with the sensor device. The evaluation device may, in particular, comprise a data processing system. The evaluation device can, in particular, be set up to generate a wear signal as a function of a pressure and/or flow detected by the sensor device, which wear signal represents the state of wear of the suction element. In this sense, a state of wear of the suction element can be determined automatically in a simple manner. The evaluation device can be provided separately from the suction pad. By way of example, it is conceivable that the evaluation device is part of a cloud computer system. In this case, the sensor device can have a communication interface, for example, a WLAN or LAN interface, by means of which measurement signals can be transmitted to the evaluation device. It is, however, also possible for the evaluation device to be located on the suction pad itself. The evaluation device can, for example, include a display device that visualizes a state of wear of the suction element.

In an advantageous manner, the evaluation device can be set up to compare a measurement signal received from the sensor device with a reference measurement signal stored in a memory device of the evaluation device in order to generate the wear signal. The wear signal can, in particular, then represent an operationally suitable state of wear of the suction element if the measurement signal exceeds a predefined threshold value, in particular one that is stored or can be stored in the memory device of the evaluation device. The wear signal can, in particular, then represent a state of wear of the suction pad that is unsuitable for operation if the measurement signal falls below the threshold value.

The task mentioned at the beginning is also solved by a method for operating a vacuum gripper according to claim 14. The features and advantages explained above in connection with the vacuum gripper can be used for the embodiment of the method.

The method is configured for operating a vacuum gripper, which comprises a pressure source, as described above, for applying pressure to the fluid channel and an evaluation device interacting with the sensor device. The method is, in particular, a method for determining the state of wear of the suction element by means of such a vacuum gripper. According to the method, pressure is initially applied to the fluid channel, in particular overpressure, more particularly compressed air, via the pressure source. It is possible for pressure to be applied continuously to the fluid channel, in particular, continuously during operation of the suction pad. It is also possible for pressure to be applied to the fluid channel only at certain time intervals (intermittently) by means of the pressure source.

While pressure is being applied, the sensor device detects a pressure in the fluid channel and/or a fluid flow through the fluid channel and forwards it to the evaluation device in the form of a measurement signal. As elucidated above, a change in the fluid channel triggered by wear can lead to a change in pressure and/or flow, which is then detected by the sensor device.

Depending on the pressure and/or flow detected by the sensor device, a wear signal is then generated by the evaluation device, which wear signal presents a state of wear of the suction element. By way of example, it is conceivable that the measurement signal generated by the sensor device is compared, by means of the evaluation device, with a reference measurement signal stored in a memory device of the evaluation device and a wear signal representing the state of wear of the suction element is then output. The evaluation device can, for example, be set up to output a wear signal which represents a state of wear that is suitable for operation if the measurement signal falls below a predetermined threshold value and/or to output a wear signal which represents a state of wear that is unsuitable for operation if the measurement signal exceeds the threshold value.

The invention will be explained in more detail below with reference to the figures.

Wherein:

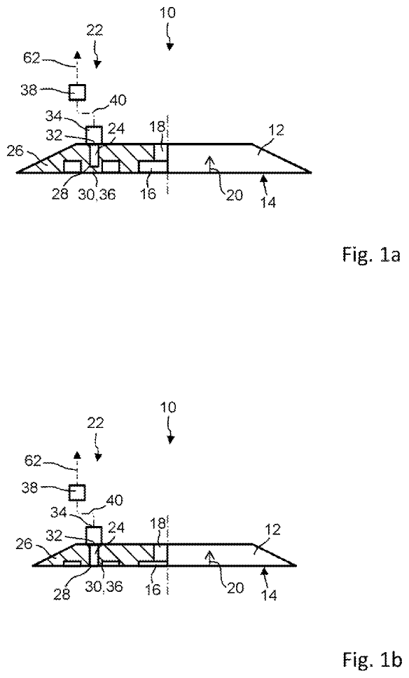

FIG. 1a shows a schematic representation of an embodiment of a vacuum gripper in a new condition in a partial cross-sectional view;

FIG. 1b shows a schematic representation of the vacuum gripper according to FIG. 1a with partially worn suction element;

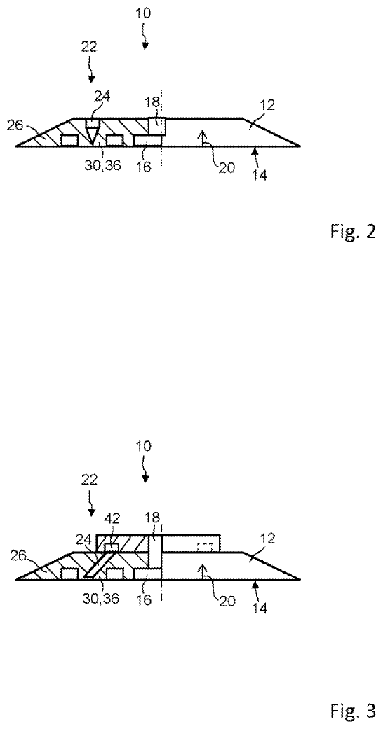

FIG. 2 shows a schematic representation of a further embodiment of a suction element in a partial cross-sectional view;

FIG. 3 shows a schematic representation of a further embodiment of a suction element in a partial cross-sectional view;

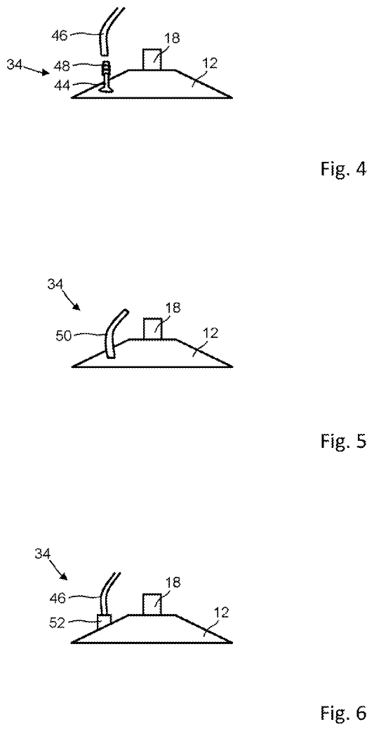

FIG. 4 shows a schematic representation of a further embodiment of a suction element in a side view;

FIG. 5 shows a schematic representation of a further embodiment of a suction element in a side view;

FIG. 6 shows a schematic representation of a further embodiment of a suction element in a side view;

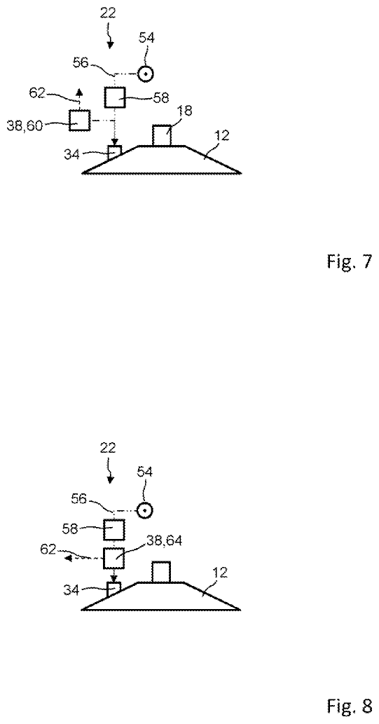

FIG. 7 shows a schematic representation of a further embodiment of a vacuum gripper in a side view; and

FIG. 8 shows a schematic representation of a further embodiment of a vacuum gripper in a side view.

In the following description, as well as in the figures, the same reference signs are used for identical or corresponding features.

FIG. 1 shows a first embodiment of a vacuum gripper, which is designated overall by the reference sign 10. The vacuum gripper 10 comprises a suction element 12, which in the example shown is configured as an elastomer suction cup. In embodiments not shown, the suction element 12 can also, for example, be a porous foam material.

The suction element 12 is used for suctioning and therefore for gripping an object (not shown). When used as intended, the suction gripper 12 is placed with a contact section 14 on an outer surface of the object to be gripped and the object is then suctioned by means of negative pressure. For this purpose, the suction element 12 comprises a plurality of negative pressure channels 16, which can be supplied with negative pressure via a negative pressure connection 18. By way of example, the negative pressure connection 18 can be connected to a negative pressure generating device (not shown). To deposit a suctioned object, the negative pressure channels 16 can once again then be vented, for example, via the connection 18.

Over the course of this intended use, which is to say, during repeated suctioning and depositing of an object, the suction element 12 is subject to use-related wear, at least in sections, particularly in the area of the contact section 14. This is illustrated schematically in FIG. 1a and FIG. 1b, which show the vacuum gripper 10 in an as-new state (see FIG. 1a) and in a used state of the suction element 12 (see FIG. 1b). A main direction of wear is indicated in the figures by the arrow marked with reference sign 20. The wear is, in particular, mechanical abrasion of the suction element material, for example, as a result of friction between the suction element 12 and the suctioned object.

In order to be able to monitor a state of wear of the suction element 12, the vacuum gripper 10 comprises a wear detection device 22. The wear detection device 22 comprises a fluid channel 24, which in the example shown is configured in the suction element 12, in particular, in a suction element wall 26. By way of example, the fluid channel 24 is arranged parallel to the main direction of wear 20. It is, however, also conceivable that the fluid channel 24 is arranged orthogonally or at an angle to the main direction of wear 20 (see FIG. 3).

In the as-new state of the suction element 12 shown in FIG. 1a, the fluid channel 24 is closed at a first channel end 28 by a material section 30 of the suction element 12. At its second channel end 32, the fluid channel 24 has a fluid interface 34, by means of which the fluid channel 24 is fluidically contactable (described in detail below with reference to FIG. 4 through FIG. 6).

Like the surrounding areas of the contact section 14 of the suction element 12, the material section 30 is subject to material abrasion when the suction element 12 is used as intended. In this respect, the material section 30 forms a wearing section 36 that interacts with the fluid channel.

When a predetermined degree of wear of the suction element 12 or the wearing section 36 is reached, which is to say, when a certain amount of material of the suction element 12 has already been worn away, the fluid channel 24 is opened at its first channel end 28 such that a fluid flow through the fluid channel 24 is possible (see FIG. 1b). In the example shown in FIG. 1b, the fluid channel 24 in the open state opens into an inner suction compartment of the suction element 12 comprising the negative pressure channels 16. Through this, a pressure or fluid flow in the fluid channel 24 is changed, which in this respect is characteristic of the current state of wear of the suction element 12.

In order to be able to detect such a change in pressure and/or flow, the wear detection device 22 comprises a correspondingly configured sensor device 38, which may, for example, comprise a pressure and/or flow sensor (explained in an exemplary manner in more detail below with reference to FIG. 7 and FIG. 8). As indicated in the figures, the sensor device 38 is flow-connected to the fluid interface 34 of the fluid channel 24 by means of a fluid line 40.

A measured pressure or flow can then, in particular, be transmitted from the sensor device 38 in the form of a measurement signal to an evaluation device (not shown) of the vacuum gripper 10 (indicated in the figures by the arrow 62). As already mentioned, the evaluation device can be configured to generate a wear signal from the measurement signal received from the sensor device 38, which wear signal represents the state of wear of the suction element 12.

FIG. 2 shows a further embodiment of a suction element 12 in which the fluid channel 24 widens conically in the direction of wear 20. In this embodiment, as the wearing section 36 or the suction element 12 progressively wears, a flow cross-section of the fluid channel 24 is increased, in particular, in a continuous manner. Such a change can then once again be detected by means of the sensor device 38 as a change in pressure and/or flow and thereby a state of wear of the suction element 12 can be determined.

FIG. 3 shows a further embodiment of the vacuum gripper 10 in which the fluid channel 24 is oriented at an angle to the main direction of wear 20. In the example shown, the fluid channel 24 opens into an annular channel 42 at its second channel end 32 facing away from the wearing section 36.

In embodiments not shown, it is also conceivable, in principle, that the fluid channel 24 and the wearing section 36 are provided by a wear body which is formed separately from the suction element 12.

Various embodiments of the fluid interface 34 are described below with reference to FIG. 4 through FIG. 6, which can be provided independently of the embodiment of the fluid channel 24.

In the embodiment shown in FIG. 4, the fluid interface 34 comprises a connection nipple 44, which is flow-connected to the fluid channel 24. The connection nipple 44 is exemplarily configured in one piece with the suction element 12. The connection nipple 44 is, in particular, configured for connection to a fluid hose 46. By way of example, the connection nipple 44 can have barbs 48 for the hose 46.

In the embodiment shown in FIG. 5, the fluid interface 34 comprises a hose 50 formed integrally with the suction element 12, which is flow-connected to the fluid channel 24 and extends away from the suction element 12.

It is also possible that the fluid interface 34 comprises an external connecting piece 52 for a hose 46. The connecting piece 52 can, for example, be provided separately from the suction element 12 and then be connected to the suction element 12, for example, by means of a plug connector (see FIG. 6).

FIG. 7 and FIG. 8 show further embodiments of the wear detection device 22, which can be provided independently of the embodiment of the fluid channel 24 or alternatively of the fluid interface 34.

In the embodiment shown in FIG. 7, the wear detection device 22 comprises a pressure source 54, which is exemplarily configured as an overpressure source. The pressure source can, in particular, be configured to apply constant pressure to the fluid channel, in particular compressed air. The pressure source 54 is flow-connected to the fluid interface 34 of the fluid channel 24 by means of a fluid connection 56 and can, for example, be selectively connected or disconnected by means of a valve 58. In this respect, pressure, in particular with compressed air, can optionally be applied to the fluid channel 24. In the embodiment shown in FIG. 7, the sensor device 38 comprises a pressure sensor 60, which is flow-connected to the fluid channel 24 by means of the fluid line 56.

To detect a state of wear of the suction element 12, pressure can be applied to the fluid channel 24, in particular with compressed air, continuously or intermittently during operation of the suction element 12 by means of the pressure source 54. Preferably, constant pressure is applied to the fluid channel 24. A resulting pressure in the fluid channel 24 can then be detected by the pressure sensor 60. If a flow cross-section in the fluid channel 24 now changes over the course of use-related wear of the suction element 12 or alternatively of the wearing section 36, or if the fluid channel 24 is actually opened, this can be detected as a change in pressure by the pressure sensor 60. As mentioned above, the pressure sensor may be connected to an evaluation device in order to determine a wear signal depending on the measured pressure.

The embodiment shown in FIG. 8 differs from the embodiment shown in FIG. 7 in that a flow sensor 64 is provided instead of the pressure sensor 60. The flow sensor 64 is configured, for example, to detect a flow, in particular a fluid flow through the fluid channel 24. In this embodiment of the wear detection device 22, a change in a flow through the fluid channel 24 as a result of wear of the wearing section 36 can be detected by means of the flow sensor 64. In this way, a state of wear of the suction element 12 can also be concluded.

1. Vacuum gripper (10), comprising:
a suction element (12) which, when used as intended, is subject to wear at least in sections as a result of use;
a wear detection device (22) for detecting a state of wear of the suction element (12), comprising:
a wearing section (36), which itself wears out over the course of use-related wear of the suction element (12);
a fluid channel (24), which interacts with the wearing section (36) in such a way that a flow cross-section of the fluid channel (24) is changed by wear of the wearing section (36) and/or a fluid flow through the fluid channel (24) is released in the first place; and
a sensor device (38) including a pressure sensor (60) and/or a flow sensor (64), for detecting a pressure in the fluid channel (24) and/or a fluid flow through the fluid channel (24).

2. Vacuum gripper (10) according to claim 1, wherein the wearing section (36) provides, at least in sections, a wall delimiting the fluid channel (24).

3. Vacuum gripper (10) according to claim 1, wherein the wearing section (36) consists of the same material as the suction element (12), is, in particular, configured in one piece with the suction element (12), is configured by a suction element wall (26).

4. Vacuum gripper (10) according to claim 1, wherein the fluid channel (24) is configured in the suction element (12) and delimited by a suction element wall (26).

5. Vacuum gripper (10) according to claim 1, wherein the wearing section (36) and the fluid channel (24) are configured in such a way that in an as-new state of the wearing section (36) the fluid channel (24) is closed at a channel end (28) of the wearing section (36) and that when a predetermined degree of wear is reached including when a predetermined amount of abrasion of the wearing section (36) is exceeded, the channel end (28) is opened.

6. Vacuum gripper (10) according to claim 1, wherein the wearing section (36) and the fluid channel (24) are configured in such a way that a flow cross-section of the fluid channel (24) increases continuously over the course of progressive wear of the wearing section (36).

7. Vacuum gripper (10) according to claim 1, wherein the fluid channel (24) widens or tapers at least in sections, widens in a funnel shape, widens conically, and widens in the direction of wear.

8. Vacuum gripper (10) according to claim 1, wherein the wearing section (36) and the fluid channel (24) are configured in such a way that when a predetermined degree of wear is reached including when a predetermined amount of abrasion of the wearing section (36) is exceeded, a fluidic connection is established between the fluid channel (24) and an inner suction compartment delimited by the suction element (12).

9. Vacuum gripper (10) according to claim 1, wherein the fluid channel (24) opens into an annular channel (42) including an annular groove arranged on the suction element (12).

10. Vacuum gripper (10) according to claim 1, wherein the fluid channel (24) comprises a fluid interface (34) for fluidically connecting the fluid channel (24) to the sensor device (38).

11. Vacuum gripper (10) according to claim 10, wherein the fluid interface (34) is formed in one piece with the suction element (12) including a connection nipple (44) for connection of a fluid line (46) and/or a hose (50) opening into the fluid channel (24).

12. Vacuum gripper (10) according to claim 1, wherein the wear detection device (22) includes a pressure source (54) including an overpressure source, which is fluidically connectable to the fluid channel (24) and is switchable by a valve (58) for applying pressure to the fluid channel (24) with overpressure from compressed air.

13. Vacuum gripper (10) according to claim 1, wherein the wear detection device (22) further comprises an evaluation device interacting with the sensor device (38), which is set up to generate a wear signal which represents the state of wear of the suction element (12) as a function of a pressure and/or flow in the fluid channel (24) detected by the sensor device (38).

14. Method for operating a vacuum gripper (10) according to claim 12,
wherein overpressure from compressed air, is applied to the fluid channel (24) by the pressure source (54),
wherein a pressure in the fluid channel (24) and/or a flow through the fluid channel (24) is detected by the sensor device (38), and
wherein a wear signal is generated by the evaluation device as a function of the detected pressure and/or flow, which signal represents a state of wear of the suction element (12).
